(19) United States
(12) Patent Application Publication
(10) Pub. No.: US 2026/0267303 A1
(43) Pub. Date: Sep. 10, 2026

(54) NON-TRANSITORY COMPUTER READABLE MEDIUM FOR CONTROL PROGRAM, CONTROL METHOD AND COMMUNICATION TERMINAL

(71) Applicant: Honda Motor Co., Ltd., Tokyo (JP)

(72) Inventors: Kaho Tonomura, Tokyo (JP); Sunao Yamaguchi, Tokyo (JP); Kaede Inoguchi, Tokyo (JP); Takaya Suzuki, Tokyo (JP)

(21) Appl. No.: 19/555,877

(22) Filed: Mar. 3, 2026

(30) Foreign Application Priority Data
Mar. 6, 2025 (JP) 2025-035838

(51) Int. Cl. G05B 15/02; B60H 1/00; B60J 3/04; B60Q 3/70; G06F 3/04847

(52) U.S. Cl. CPC G05B 15/02; B60H 1/00657; B60H 1/00978; B60J 3/04; B60Q 3/70; B60Q 2900/30; G06F 3/04847

(57) ABSTRACT

A non-transitory computer-readable storage medium stores a control program configured to be executed by a computer of a user terminal including an input unit and a memory, the control program for controlling an in-vehicle device. The memory stores, in advance, adjustment width information defining an adjustment width of an item to be controlled of the in-vehicle device. The control program causes the computer to perform: receiving an adjustment instruction for the item to be controlled input via the input unit; and restricting either an input of the adjustment instruction or reception of the adjustment instruction to impose a predetermined restriction on the adjustment instruction, based on the adjustment width defined by the adjustment width information.

### CROSS-REFERENCE TO RELATED APPLICATION

This application is based upon and claims the benefit of priority from Japanese Patent Application No. 2025-035838 filed on Mar. 6, 2025, the content of which is incorporated herein by reference.

### BACKGROUND

### Technical Field

The present disclosure relates to a non-transitory computer readable medium for control program, a control method and a communication terminal.

### Related Art

There is conventionally disclosed an apparatus, which is configured to connect an in-vehicle navigation device equipped in a vehicle with a portable terminal device individually possessed by an occupant to enable data communication so that an in-vehicle control apparatus can be remotely operated (for example, see JP 2002-87184 A). In the apparatus described in JP 2002-87184 A, in a case where the position in the vehicle of the portable information terminal identified by the position identification means is located in a front seat area, at least one remote operation of the in-vehicle control apparatus is prohibited, and in a case where its position is located in a back seat area, at least a part of the remote operation of the in-vehicle control apparatus is shared.

However, as in the apparatus described in JP 2002-87184 A, when the remote operation of the in-vehicle control apparatus is performed in accordance with the seat position of an occupant, an uncomfortable feeling may be given to another occupant depending on an adjustment width in the remote operation.

### SUMMARY

An aspect of the present invention is a non-transitory computer-readable storage medium storing a control program configured to be executed by a computer of a user terminal including an input unit and a memory, the control program for controlling an in-vehicle device. The memory stores, in advance, adjustment width information defining an adjustment width of an item to be controlled of the in-vehicle device. The control program causes the computer to perform: receiving an adjustment instruction for the item to be controlled input via the input unit; and restricting either an input of the adjustment instruction or reception of the adjustment instruction to impose a predetermined restriction on the adjustment instruction, based on the adjustment width defined by the adjustment width information.

Another aspect of the present invention is a control method for control an in-vehicle device, the control method including: reading from a memory, adjustment width information defining an adjustment width of an item to be controlled of the in-vehicle device; receiving an adjustment instruction for the item to be controlled input via the input unit; and restricting either an input of the adjustment instruction or reception of the adjustment instruction to impose a predetermined restriction on the adjustment instruction, based on the adjustment width defined by the adjustment width information.

Still another aspect of the present invention is a communication terminal including: a microprocessor; a memory connected to the microprocessor and stored adjustment width information defining an adjustment width of an item to be controlled of the in-vehicle device; an input unit configured operated by a user and configured to be able to input an adjustment instruction for the item to be controlled. The microprocessor is configured to perform: receiving an adjustment instruction for the item to be controlled input via the input unit; and restricting either an input of the adjustment instruction or reception of the adjustment instruction to impose a predetermined restriction on the adjustment instruction, based on the adjustment width defined by the adjustment width information.

### BRIEF DESCRIPTION OF THE DRAWINGS

The objects, features, and advantages of the present invention will become clearer from the following description of embodiments in relation to the attached drawings, in which:

FIG. 1A is a block diagram schematically illustrating an overall configuration of an in-vehicle device control system according to an embodiment of the present invention;

FIG. 1B is a block diagram illustrating a configuration of main components of the control apparatus in FIG. 1A;

FIG. 1C is a block diagram illustrating a configuration of main components of the user terminal in FIG. 1A;

FIG. 1D is a diagram for describing the in-vehicle device in FIG. 1A;

FIG. 2A is a diagram illustrating an example of a display screen of a display unit, which is included in the user terminal;

FIG. 2B is a diagram illustrating another example of the display screen of the display unit, which is included in the user terminal;

FIG. 2C is a diagram illustrating still another example of the display screen of the display unit, which is included in the user terminal;

FIG. 3 is a diagram illustrating an example of a function restriction operation screen;

FIG. 4 is a flowchart illustrating an example of processing performed by a controller of the user terminal;

FIG. 5 is a flowchart illustrating an example of the processing performed in step S108 in FIG. 4;

FIG. 6 is a block diagram illustrating a configuration of main components of a reproduction apparatus;

FIG. 7A is a diagram illustrating an example of an operation screen of the user terminal when requesting music reproduction;

FIG. 7B is a diagram illustrating another example of the operation screen of the user terminal when requesting the music reproduction;

FIG. 7C is a diagram illustrating still another example of the operation screen of the user terminal when requesting the music reproduction;

FIG. 7D is a diagram illustrating still another example of the operation screen of the user terminal when requesting the music reproduction;

FIG. 8A is a diagram for describing reservation of the music reproduction;

FIG. 8B is a diagram for describing reservation of the music reproduction; and

FIG. 9 is a flowchart illustrating an example of processing performed by the controller of the reproduction apparatus.

### DETAILED DESCRIPTION

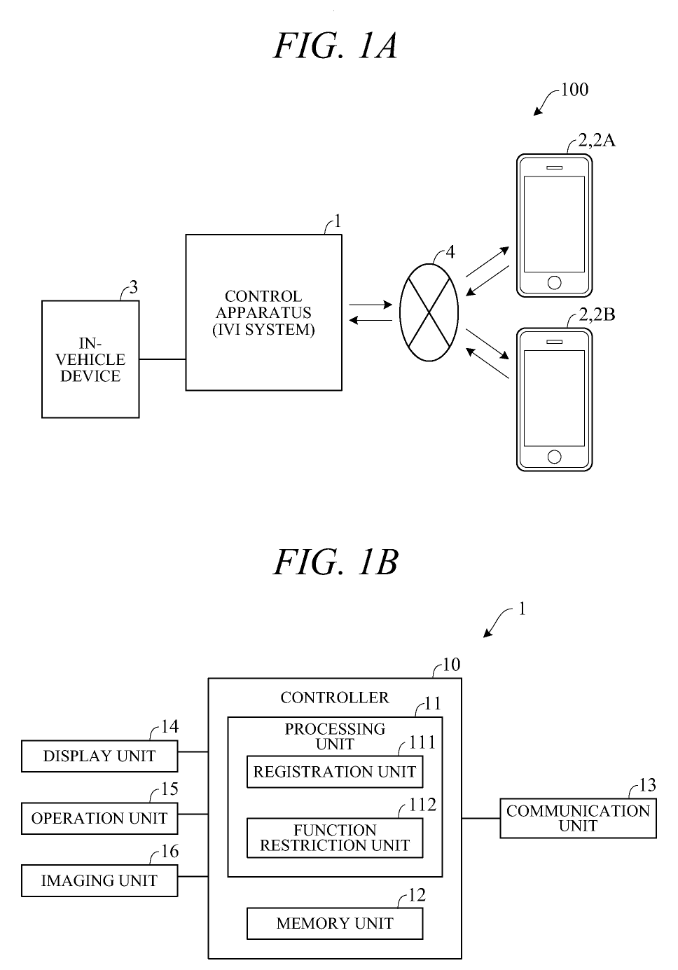

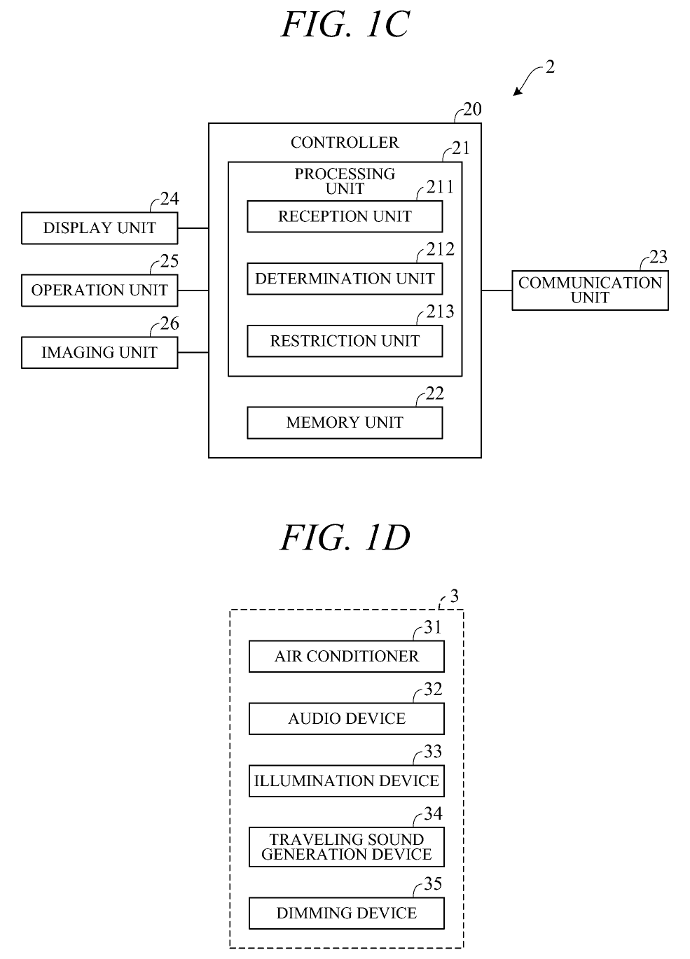

Hereinafter, embodiments of the invention will be described with reference to the drawings. FIG. 1A is a block diagram schematically illustrating an overall configuration of an in-vehicle device control system (hereinafter, simply referred to as a control system) 100 according to the present embodiment. As illustrated in FIG. 1A, the control system 100 includes a control apparatus 1 and user terminals 2 (2A and 2B). The control apparatus 1 and each of the user terminals 2 are communicably connected through a communication network 4.

The communication network 4 includes not only a public wireless communication network represented by the Internet network, a mobile telephone network, or the like but also a closed communication network provided for every predetermined management region, for example, a wireless LAN, Wi-Fi (registered trademark), Bluetooth (registered trademark), or the like.

The control apparatus 1 functions as a part of an in-vehicle infotainment (IVI) system mounted on a vehicle. The control apparatus 1 is communicably connected with an in-vehicle device 3 including an air conditioner and the like through a communication network, not illustrated, such as a controller area network (CAN).

The user terminals 2A and 2B each are a communication terminal such as a smartphone used by an occupant of the vehicle. Note that although FIG. 1A illustrates two user terminals 2A and 2B, any number of user terminals may be connected with the control apparatus 1.

FIG. 1B is a block diagram illustrating a configuration of main components of the control apparatus 1 in FIG. 1A. The control apparatus 1 includes a controller 10, a communication unit 13, a display unit 14, an operation unit 15, and an imaging unit 16.

The communication unit 13 is a communication interface that connects the control apparatus 1 to the communication network 4 and a CAN, not illustrated. The control apparatus 1 transmits and receives information to and from the user terminal 2 connected with the communication network 4 via the communication unit 13. In addition, the control apparatus 1 transmits and receives information to and from the in-vehicle device 3 connected with the CAN via the communication unit 13. The display unit 14 includes a display device included in a navigation device, not illustrated, or the like mounted on the vehicle. The operation unit 15 is configured to be capable of inputting various instructions from the user on a touch panel included in the display device. The imaging unit 16 includes a camera, which includes an imaging element such as a CCD or a CMOS, and which is installed inside the vehicle.

The controller 10 includes a computer including a processing unit 11 such as a microprocessor (CPU), a storage unit 12 such as a ROM and a RAM, and other peripheral circuits, not illustrated, such as an I/O interface. By executing a program stored in the storage unit 12, the processing unit 11 functions as a registration unit 111 and a function restriction unit 112.

The registration unit 111 registers the user terminal 2 in the IVI system in response to a registration request from the user terminal 2 through the communication network 4.

Specifically, upon reception of a predetermined operation by the user via the operation unit 15, the registration unit 111 displays a two-dimensional code (a QR code (registered trademark)) for Wi-Fi connection on the display unit 14. When the user operates the user terminal 2 to read (image) the two-dimensional code displayed on the display unit 14, a Wi-Fi connection request as a registration request is transmitted from the user terminal 2. The registration unit 111 performs authentication processing on the connection request. When the authentication is successful, the registration unit 111 stores, in the storage unit 12, unique information (for example, a MAC address) of the user terminal 2 included in the connection request. Thus, the user terminal 2 is registered in the IVI system. Hereinafter, the user terminal 2 being registered in the IVI system will be expressed as the user terminal 2 being registered to be used for the in-vehicle device 3.

When the user terminal 2 is registered in the IVI system, the registration unit 111 issues (transmits) registration information (ID, authentication information, and the like) indicating that the user terminal 2 is already registered in the IVI system to the user terminal 2. The issued registration information is stored in a storage unit 22 of the user terminal 2 as information indicating a registration status of the user terminal 2 in the IVI system (the control apparatus 1).

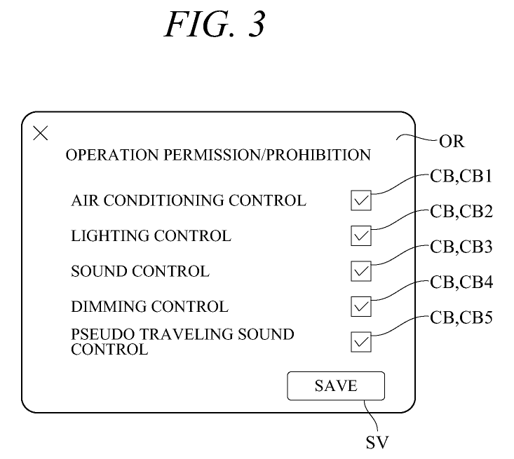

Upon reception of a predetermined operation by a driver or the like via the operation unit 15, the function restriction unit 112 displays, on the display unit 14, an operation screen (hereinafter, referred to as a function restriction operation screen) for setting the function restriction of the respective devices 31 to 35 of the in-vehicle device 3. When the driver or the like operates the function restriction operation screen via the operation unit 15 and performs settings about the function restriction of the respective devices 31 to 35, the function restriction unit 112 stores, in the storage unit 12, information (hereinafter, referred to as function restriction information) indicating the setting contents of the function restriction. The function restriction operation screen will be described later with reference to FIG. 3.

FIG. 1C is a block diagram illustrating a configuration of main components of the user terminal 2 in FIG. 1A. The user terminal 2 includes a controller 20, a communication unit 23, a display unit 24, an operation unit 25, and an imaging unit 26. The storage unit 22 stores beforehand adjustment width information that defines an adjustment width and an adjustable amount of each setting item of the in-vehicle device 3. In addition, the storage unit 22 further stores programs for various types of control and information such as threshold values for use in the programs.

The communication unit 23 is a communication interface that connects the user terminal 2 to the communication network 4. The display unit 24 is made up of a display device such as a liquid crystal display or an organic EL display including a touch panel. The operation unit 25 is made up of a touch panel included in the display unit 24, and is configured to be capable of inputting various instructions from the user. The imaging unit 26 is made up of a camera including an imaging element such as a CCD or a CMOS.

The controller 20 is configured with a computer including a processing unit 21 such as a microprocessor (CPU), the storage unit 22 such as a ROM and a RAM, and other peripheral circuits, not illustrated, such as an I/O interface. By reading and executing an application program (hereinafter, referred to as a control application) for controlling the in-vehicle device 3 and stored in the storage unit 22, the processing unit 21 functions as a reception unit 211, a determination unit 212, and a restriction unit 213.

The reception unit 211 displays, on the display unit 24, a screen (hereinafter, referred to as a change operation screen) for receiving a change instruction for the in-vehicle device 3. Specifically, the reception unit 211 outputs, on the display unit 24, screen information (hereinafter, referred to as change operation screen information) for displaying the change operation screen. The change instruction for the in-vehicle device 3 includes an adjustment instruction for each setting item of the in-vehicle device 3.

Note that the change operation screen information corresponding to each device of the in-vehicle device 3 is stored beforehand in the storage unit 12, and the change operation screen information is edited by the restriction unit 213 as will be described later. The reception unit 211 outputs, on the display unit 24, the change operation screen information that has been edited by the restriction unit 213.

FIG. 1D is a diagram for describing the in-vehicle device 3 in FIG. 1A. As illustrated in FIG. 1D, the in-vehicle device 3 includes an air conditioner 31, an audio device 32, an illumination device 33, a pseudo traveling sound generation device (hereinafter, simply referred to as the traveling sound generation device) 34, and a dimming device 35.

The air conditioner 31 is mounted on the vehicle, and adjusts the air (air conditioning) in the inside of the vehicle in accordance with a command from the control apparatus 1.

The audio device 32 is mounted on the vehicle, converts music data received from the control apparatus 1 into audio signals in response to a command from the control apparatus 1, and outputs the audio signals to a speaker provided inside the vehicle. In a case where the command from the control apparatus 1 includes information designating the speaker of an output destination, the audio signals of the music are output to the designated speaker in accordance with the information. In addition, the control apparatus 1 may convert music data into audio signals, and the audio device 32 may output the audio signals received from the control apparatus 1 to a speaker.

The illumination device 33 is mounted on the vehicle, and outputs a control signal for selectively changing brightness, color, a light emission pattern, and the like to an ambient light provided inside the vehicle (for example, a door trim or a center console) in accordance with a command from the control apparatus 1. In a case where information designating the light to be controlled is included in the command from the control apparatus 1, a control signal is output to the designated light in accordance with the information.

The traveling sound generation device 34 is mounted on the vehicle, generates audio signals for generating a pseudo traveling sound imitating a traveling sound (an engine sound or a motor sound) in response to a command from the control apparatus 1, and outputs generated audio signals to a speaker provided at a predetermined position in a front part or a rear part of the vehicle. In a case where the command from the control apparatus 1 includes the information designating the speaker of the output destination, the audio signals of the pseudo traveling sound are output to the designated speaker in accordance with the information. Note that the pseudo traveling sound may be output to a speaker provided inside the vehicle.

The dimming device 35 is mounted on the vehicle, and controls the transmittance of dimming glass adopted for a sunroof or a rear side window of the vehicle in accordance with a command from the control apparatus 1. Specifically, the dimming device 35 outputs a control signal to a control circuit of the dimming glass. In a case where the command from the control apparatus 1 includes information designating the dimming glass to be controlled, a control signal is output to the designated dimming glass in accordance with the information.

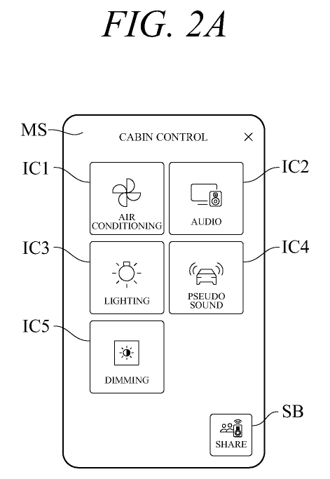

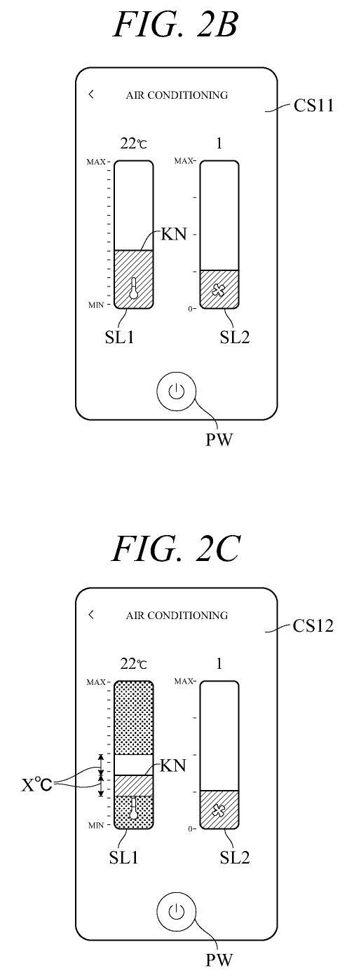

FIGS. 2A, 2B, and 2C are diagrams illustrating examples of a display screen of the display unit 24, which is included in the user terminal 2. FIG. 2A illustrates a main screen MS of the control application. When the user who uses the user terminal 2 operates the operation unit 25 to start the control application installed in the user terminal 2, the main screen MS illustrated in FIG. 2A is displayed on the display unit 24. Operation buttons (icons) IC1 to IC5, which correspond to the respective devices 31 to 35 included in the in-vehicle device 3, and which are for displaying a change operation screen on the display unit 24, are displayed on the main screen MS.

In addition, an operation button (hereinafter, referred to as a share button) SB for displaying the two-dimensional code (the QR code (registered trademark)) for Wi-Fi connection on the display unit 24 is displayed on the main screen MS. For example, a user A who uses the user terminal 2A taps the share button SB to present the two-dimensional code displayed on the display unit 24 to a user B who uses the user terminal 2B. When the user B operates the user terminal 2B and images the two-dimensional code displayed on the display unit 14 of the user terminal 2A, a Wi-Fi connection request as a registration request is transmitted from the user terminal 2B to the IVI system (the control apparatus 1). Thus, the user terminal 2B is registered in the IVI system. In this manner, the share button SB provides a function of sharing the control application between the users.

The user operates the operation unit 25 to display a change operation screen for one device of the devices 31 to 35 on the display unit 24, and inputs a change instruction for such one device on the change operation screen. For example, in changing a setting item of the air conditioner 31, the user operates the operation unit 25 to display the change operation screen of the air conditioner 31, and inputs an adjustment instruction for the setting item such as a temperature or an air volume of the air conditioner 31 on the change operation screen. Hereinafter, the setting item intended for the adjustment instruction will be referred to as an item to be controlled. The reception unit 211 receives a change instruction (an adjustment instruction for an item to be controlled) for the in-vehicle device 3 that has been input on the change operation screen.

When the reception unit 211 receives the change instruction for the in-vehicle device 3, the determination unit 212 first determines whether the user terminal 2 is a registered terminal registered in the IVI system or an unregistered terminal that is not registered. Specifically, in a case where the registration information issued from the IVI system (the control apparatus 1) is stored in the storage unit 12, the determination unit 212 determines that the user terminal 2 is the registered terminal. In a case where the registration information is not stored in the storage unit 12, the determination unit 212 determines that the user terminal 2 is the unregistered terminal.

Upon determination that the user terminal 2 is the unregistered terminal, the determination unit 212 outputs a display request for the two-dimensional code for Wi-Fi connection to the control apparatus 1. Upon reception of the above display request via the communication unit 13, the registration unit 111 of the control apparatus 1 displays the two-dimensional code on the display unit 14. Note that instead of outputting the display request for the two-dimensional code to the control apparatus 1, a registration operation request screen (not illustrated) may be displayed on the display unit 24. The registration operation request screen includes a message for prompting registration of the user terminal 2 in the IVI system. In response to such a message, the user of the user terminal 2 performs a predetermined operation on the operation unit 15 of the control apparatus 1 to display the two-dimensional code on the display unit 14 of the control apparatus 1.

When the two-dimensional code is displayed on the display unit 14, the user operates the imaging unit 26 via the operation unit 25, and reads (images) the two-dimensional code. The determination unit 212 acquires information (such as a network name and a password) stored in the two-dimensional code, based on the captured image acquired by the imaging unit 26. The determination unit 212 transmits the Wi-Fi connection request as the registration request together with the acquired information to the IVI system (the control apparatus 1).

In addition, the determination unit 212 determines whether to enable or disable the adjustment instruction for each setting item of the in-vehicle device 3, based on the registration status of the user terminal 2 in the IVI system indicated by the registration information stored in the storage unit 12.

Specifically, when the user terminal 2 is not registered in the IVI system, the determination unit 212 determines that the change instruction for each setting item of the air conditioner 31 and the audio device 32 is enabled. In addition, the determination unit 212 determines that the change instruction for each setting item of the illumination device 33, the traveling sound generation device 34, and the dimming device 35 is disabled. On the other hand, in a case where the user terminal 2 is registered in the IVI system, the determination unit 212 determines that the adjustment instruction for each setting item of the in-vehicle device 3 is enabled regardless of the type of the in-vehicle device 3.

Note that the driver or the like is able to set beforehand whether to enable or disable the change instruction for the in-vehicle device 3 on the function restriction operation screen displayed on the display unit 14 of the control apparatus 1. Specifically, first, upon reception of a predetermined operation via the operation unit 15, the function restriction unit 112 of the control apparatus 1 displays the function restriction operation screen on the display unit 14. FIG. 3 is a diagram illustrating an example of the function restriction operation screen.

As illustrated in FIG. 3, the function restriction operation screen OR includes check boxes CB (CB1 to CB5) corresponding to the respective devices 31 to 35 and a save button SV. The driver or the like turns on or off the check box CB via the operation unit 15. When the check box CB is turned on, the change instruction for the corresponding device is enabled. When the check box CB is turned off, the change instruction for the corresponding device is disabled. When the save button SV is tapped, the function restriction unit 112 of the control apparatus 1 stores, in the storage unit 12, information indicating the on/off states of the check boxes CB1 to CB5, that is, information indicating whether the change instruction for each of the devices 31 to 35 is enabled, as the function restriction information. Note that the initial state of each of the check boxes CB1 to CB5 is on.

The determination unit 212 outputs a transmission request for the function restriction information to the control apparatus 1, and receives the function restriction information that has been transmitted from the control apparatus 1 as a response to the transmission request. The determination unit 212 determines whether to permit (enable) or prohibit (disable) the change instruction for each setting item, based on the function restriction information that has been received.

The restriction unit 213 restricts an input of an adjustment instruction on the change operation screen to suppress an uncomfortable feeling to be given to another occupant and possibly caused by the adjustment of the setting item. More specifically, the restriction unit 213 changes the adjustment width defined beforehand for every setting item in accordance with the adjustment width information to reduce an upper limit and increase a lower limit. In addition, the restriction unit 213 reduces the adjustable amount defined beforehand for every setting item in accordance with the adjustment width information. The adjustable amount denotes a maximum amount to be changeable in one adjustment instruction. The restriction unit 213 edits (updates) the change operation screen information, based on a changed adjustment width and a changed adjustable amount. Thus, the change operation screen in which the adjustment width and the adjustable amount of each setting item are changed is displayed on the display unit 24. The restriction unit 213 outputs, to the control apparatus 1, the adjustment instruction that has been input by the user on the change operation screen.

FIG. 2B illustrates a change operation screen CS11 of the air conditioner 31 before update. The change operation screen CS11 includes a power button PW for turning on/off the power supply of the air conditioner 31, a slider SL1 for adjusting the set temperature of the air conditioner 31, and a slider SL2 for adjusting the air volume level. In the slider SL1, an upper end portion KN of a shaded region functions as an indicator indicating the current set temperature, and it is possible to change the set temperature by moving the upper end portion up and down. Similarly, on the slider SL2, it is also possible to change the air volume level by moving an upper end portion of a shaded region.

FIG. 2C illustrates a change operation screen CS12 of the air conditioner 31 that has been updated by the restriction unit 213. When the user who uses the user terminal 2 operates the operation unit 25 and taps the icon IC1 on the main screen MS, the restriction unit 213 reads screen information corresponding to the change operation screen CS11 of FIG. 2B from the storage unit 22. The restriction unit 213 edits the screen information that has been read so that the adjustment instruction to be input on the change operation screen CS11 is restricted. Thus, the screen information corresponding to the change operation screen CS12 of FIG. 2C is generated.

In the change operation screen CS12 of FIG. 2C, an operable range of the slider SL1 is restricted so that it is not possible to significantly change the set temperature of the air conditioner 31 in one adjustment instruction. Specifically, the movement of an indicator KN of the slider SL1 is restricted to be within a range of ± X (for example, three) degrees from the current set temperature. Dotted regions in the slider SL1 indicate that it is not possible to move the indicator KN to such regions.

Note that the change operation screen CS12 of FIG. 2C illustrates an example in which the adjustable amount of the set temperature of the air conditioner 31, that is, an adjustment amount that can be designated in one adjustment instruction is restricted. However, the adjustment width of the set temperature of the air conditioner 31 may be restricted by narrowing the width of the slider SL1 in an up-down direction. In addition, a similar restriction may be imposed on the adjustment instruction for the air volume level of the air conditioner 31. That is, at least one of the adjustable amount and the adjustment width of the air volume level of the air conditioner 31 may be restricted.

In addition, the adjustment width of the luminance of the ambient light may be restricted on a change operation screen (not illustrated) for the illumination device 33. Specifically, the restriction unit 213 may change the maximum luminance and the minimum luminance that define an adjustment width of the luminance to narrow such a width. For example, by reducing the maximum luminance by 25% and increasing the minimum luminance by 25%, the restriction unit 213 may restrict the adjustment width to fall within a range of 50% at the center so as to suppress an uncomfortable feeling to be given to another occupant by the luminance adjustment.

Further, at least one of the adjustable amount and the adjustment width of the volume may be restricted on the change operation screen (not illustrated) for the audio device 32. For example, by reducing the maximum volume by 20% and increasing the minimum volume by 20%, the restriction unit 213 may restrict the adjustment width to a range of 60% at the center to suppress an uncomfortable feeling to be given to another occupant by the volume adjustment.

In addition, at least one of the adjustable amount and the adjustment width of the transmittance of the dimming glass may be restricted on a change operation screen (not illustrated) for the dimming device 35. For example, the restriction unit 213 may restrict the adjustment amount of the transmittance that can be designated in one adjustment instruction to fall within a range of ± 50% of the current transmittance in consideration of safety of the driver and the like.

Note that the restriction unit 213 may prohibit an input of a specific change instruction for the in-vehicle device 3 in consideration of safety of the driver and the like. For example, in a case where switching between outside air introduction and inside air circulation is included in the setting items of the air conditioner 31, the change operation screen information of the air conditioner 31 may be edited so that such a switching operation cannot be performed.

In addition, in a case where the user terminal 2 is an unregistered terminal, the restriction unit 213 may put a stricter restriction on the adjustment instruction for the item to be controlled than that in a case where the user terminal 2 is a registered terminal. Specifically, the restriction unit 213 may change the maximum value and the minimum value that define the adjustment width to make the adjustment width of the item to be controlled narrower than that in the case where the user terminal 2 is the registered terminal. Further, the restriction unit 213 may make the adjustable amount of the item to be controlled smaller than that in the case where the user terminal 2 is the registered terminal.

In addition, in a case where the user of the user terminal 2 is a child, the restriction unit 213 may impose a stricter restriction on the adjustment instruction for the item to be controlled than that in a case where the user of the user terminal 2 is an adult. In this case, the restriction unit 213 determines whether the user of the user terminal 2 is an adult, based on the user information stored beforehand in the storage unit 22. The user information includes at least information from which the age of the user of the user terminal 2 is identifiable. Note that the restriction unit 213 may determine whether the user is an adult, based on the captured image of the user that has been acquired by the imaging unit 26. Further, the restriction unit 213 may acquire, from the control apparatus 1, a captured image of the inside of the vehicle that has been acquired by the imaging unit 16, and may determine whether the user who is present inside the vehicle is an adult, based on the captured image.

Furthermore, the restriction unit 213 restricts the input of the change instruction that has been determined to be disabled by the determination unit 212. More specifically, the restriction unit 213 edits the screen information of the change operation screen to make the operation inoperable on the change operation screen corresponding to the in-vehicle device 3, the change instruction for which has been determined to be disabled. Note that the restriction unit 213 may edit the screen information of the main screen MS not to display the change operation screen corresponding to the in-vehicle device 3, the change instruction for which has been determined to be disabled. Specifically, the restriction unit 213 may edit the screen information of the main screen MS to disable (make inoperable) the operation button (icon) IC for displaying the change operation screen on the display unit 24.

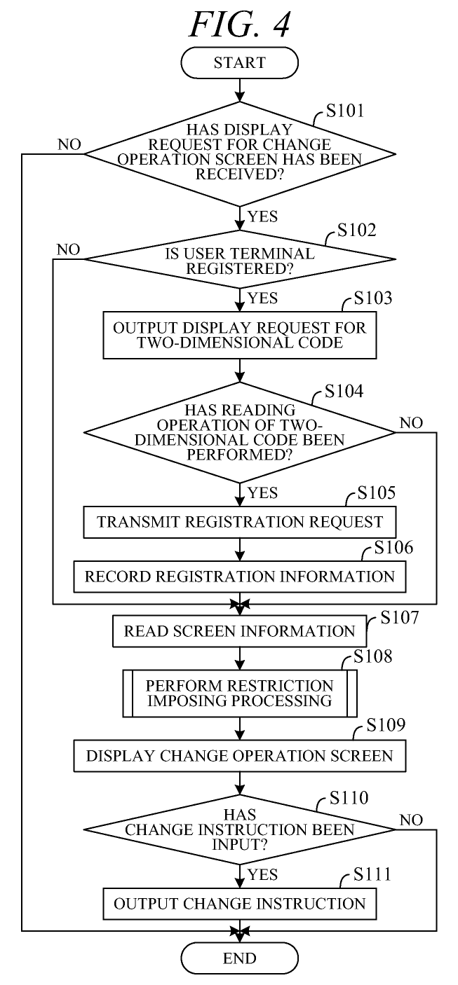

FIG. 4 is a flowchart illustrating one example of processing performed by the controller 20 of the user terminal 2 in accordance with a predetermined program. The processing illustrated in the flowchart is started when the control application is activated, and is repeated at a predetermined cycle while the control application is running.

First, in step S101, the controller 20 determines whether a display request for the change operation screen has been received. Specifically, the controller 20 determines whether any of the icons IC1 to IC5 on the main screen MS displayed on the operation unit 25 has been tapped. In a case where a negative determination is made in step S101, the processing ends. In a case where an affirmative determination is made in step S101, the controller 20 determines whether the user terminal 2 is an unregistered terminal in step S102.

In a case where a negative determination is made in step S102, that is, in a case where it is determined that the user terminal 2 is a registered terminal, the processing proceeds to step S107. In a case where an affirmative determination is made in step S102, the controller 20 outputs a display request for the two-dimensional code to the control apparatus 1 in step S103. Thus, the two-dimensional code is displayed on the display unit 14 of the control apparatus 1.

In step S104, the controller 20 determines whether a reading operation of reading the two-dimensional code displayed on the display unit 14 of the control apparatus 1 has been performed, that is, whether a captured image of the two-dimensional code has been acquired by the imaging unit 26. In a case where the reading operation is not performed even after a certain period of time elapses, the controller 20 makes a negative determination in step S104, and proceeds to a process of step S107. Note that the controller 20 may make a negative determination in step S104 upon detection of an operation for interrupting the reading operation via the operation unit 25.

In a case where an affirmative determination is made in step S104, the controller 20 acquires information (such as a network name and a password) stored in the two-dimensional code, based on the captured image of the two-dimensional code in step S105. The controller 20 transmits, to the IVI system (the control apparatus 1), a Wi-Fi connection request as a registration request together with the acquired information. In step S106, the controller 20 stores, in the storage unit 22, the registration information that has been issued by the IVI system in response to the registration request.

In step S107, the controller 20 reads the screen information of the change operation screen corresponding to the display request received in step S101 from the storage unit 22. For example, when the icon IC1 is tapped in step S101, that is, upon reception of a request for displaying the change operation screen of the air conditioner 31, the controller 20 reads the screen information corresponding to the change operation screen CS11 of FIG. 2B from the storage unit 22.

The controller 20 edits the screen information that has been read, based on the registration information stored in the storage unit 22. Specifically, in a case where the user terminal 2 is an unregistered terminal and a device to be adjusted is the illumination device 33, the traveling sound generation device 34, or the dimming device 35, the controller 20 edits the screen information to make the change operation screen inoperable. In this case, the controller 20 may edit the screen information to display a message indicating that the operation for the in-vehicle device 3 from the unregistered terminal is not permitted on the change operation screen. On the other hand, in a case where the user terminal 2 is the unregistered terminal and the device to be adjusted is the air conditioner 31 or the audio device 32, the screen information is edited to make the change operation screen operable. In a case where the user terminal 2 is a registered terminal, the screen information is edited to make the change operation screen operable regardless of the type of the device to be adjusted.

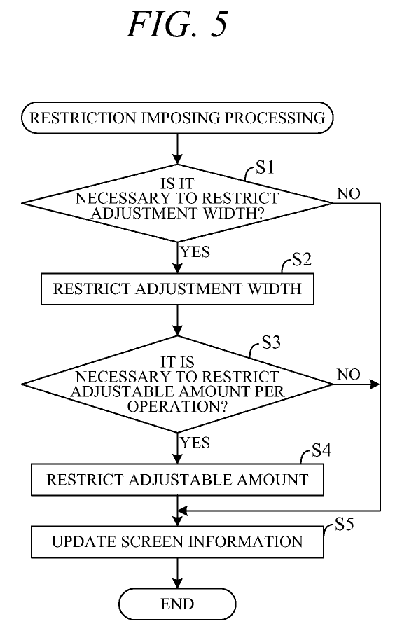

In step S108, restriction imposing processing is performed. Details of the restriction imposing processing will be described in detail with reference to FIG. 5. In step S109, the screen information after the restriction imposing processing is output to the display unit 24. Thus, the change operation screen into which the input is restricted is displayed on the display unit 24. In step S110, the controller 20 determines whether a change instruction has been input on the change operation screen. In a case where a negative determination is made in step S110, the controller 20 ends the processing. In a case where an affirmative determination is made in step S110, the controller 20 outputs the change instruction input in step S110 to the control apparatus 1 in step S111. The change instruction includes information indicating a device to be adjusted and a setting item, and an adjustment instruction. The control apparatus 1 transmits a control signal (a command) based on the change instruction that has been received to the device to be adjusted through the CAN.

FIG. 5 is a flowchart illustrating one example of the restriction imposing processing performed in step S108 in FIG. 4. First, in step S1, the controller 20 determines whether it is necessary to restrict the adjustment width for every setting item of the device to be adjusted. In a case where there is no setting item that has been determined that it is necessary to restrict the adjustment width, a negative determination is made in step S1, and the controller 20 proceeds to a process of step S3. In a case where there is a setting item that has been determined that it is necessary to restrict the adjustment width, an affirmative determination is made in step S1, and the controller 20 changes the adjustment width of such a setting item to reduce the upper limit and increase the lower limit in step S2.

In step S3, the controller 20 determines whether it is necessary to restrict the adjustable amount for every setting item of the device to be adjusted. In a case where there is no setting item that has been determined that it is necessary to restrict the adjustable amount, a negative determination is made in step S3, and the controller 20 proceeds to a process of step S5. In a case where there is a setting item that has been determined that it is necessary to restrict the adjustable amount, an affirmative determination is made in step S3, and the controller 20 reduces the adjustable amount of such a setting item in step S4.

In step S5, the controller 20 edits (updates) the screen information to correspond to a changed adjustment width and a changed adjustable amount. Thus, for example, in a case where the device to be adjusted is the air conditioner 31, the screen information corresponding to the change operation screen CS12 (FIG. 2C) is generated.

According to the embodiments described heretofore, the following effects are achievable.

(1) The user terminal 2 as a communication terminal includes the operation unit 25 as an input unit, and the storage unit 22, and controls the in-vehicle device 3 via the IVI system. The storage unit 22 stores beforehand the adjustment width information that defines an adjustment width of an item to be controlled of the in-vehicle device 3. The user terminal 2 further includes: the reception unit 211, which receives an adjustment instruction for the item to be controlled that has been input via the operation unit 25; and the restriction unit 213, which restricts either an input of the adjustment instruction or reception of the adjustment instruction to impose a predetermined restriction on the adjustment instruction, based on the adjustment width defined by the adjustment width information. The restriction unit 213 prohibits the input of the adjustment instruction that exceeds a predetermined restriction into the operation unit 25. More specifically, the restriction unit 213 conducts at least one of reducing the upper limit of the adjustment width defined by the adjustment width information and increasing the lower limit of the adjustment width. In addition, the restriction unit 213 reduces the adjustable amount in one adjustment instruction defined by the adjustment width information. Thus, an uncomfortable feeling of an occupant to be caused by remotely operating the in-vehicle device can be suppressed.

(2) The user terminal 2 further includes a display unit 24. The reception unit 211 outputs screen information for displaying an operation screen capable of receiving an adjustment instruction to the display unit 24, and receiving the adjustment instruction for the operation screen via the operation unit 25. The restriction unit 213 edits the screen information to enable or disable input of the adjustment instruction for the operation screen, and outputs the edited screen information to the display unit 24, or controls whether to output the adjustment instruction for the operation screen to the in-vehicle device 3, thereby enabling or disabling reception of the adjustment instruction in the in-vehicle device 3.

(3) The storage unit 22 further stores the registration information indicating a registration status of the user terminal 2 with respect to the in-vehicle device 3. The user terminal 2 further includes the determination unit 212 as a determination unit that determines whether the user terminal is a registered terminal registered in the in-vehicle device or an unregistered terminal that is not registered, based on the registration information. The predetermined restriction includes a first restriction and a second restriction, which is stricter than the first restriction. The restriction unit restricts the input of adjustment instruction in such a manner that in a case where it is determined that the user terminal 2 is the registered terminal, the restriction unit imposes the first restriction on the adjustment instruction, and in a case where it is determined that the user terminal 2 is the unregistered terminal, the restriction unit imposes the second restriction on the adjustment instruction. Thus, a stricter restriction is imposed on the adjustment instruction from the unregistered terminal, so that a remote operation for a large adjustment width by the user of the unregistered terminal can be suppressed.

(4) The storage unit further stores the user information from which the age of the user of the user terminal 2 is identifiable. The determination unit 212 as a determination unit determines whether the user is an adult, based on the user information. The predetermined restriction includes a first restriction and a second restriction, which is stricter than the first restriction. The restriction unit 213 restricts the input of the adjustment instruction in such a manner that in a case where it is determined that the user is an adult, the restriction unit 213 imposes the first restriction on the adjustment instruction, and in a case where it is determined that the user is a child, the restriction unit 213 imposes the second restriction on the adjustment instruction. Thus, a remote operation for a large adjustment width by a child can be suppressed.

(5) The in-vehicle device 3 is the illumination device 33, and the item to be controlled is the luminance of the illumination device 33. The restriction unit 213 reduces the upper limit of the adjustment width of the luminance of the illumination device 33 to be lower than a predetermined lower limit value set beforehand, and increases the lower limit of the adjustment width to be higher than a predetermined lower limit value set beforehand. Thus, a remote operation for a large adjustment width in the luminance setting of the illumination device 33 can be suppressed.

(6) The in-vehicle device 3 is the air conditioner 31. The restriction unit 213 prohibits switching between outside air introduction and inside air circulation by the air conditioner 31. Thus, a remote operation for switching between the outside air introduction and the inside air circulation of the air conditioner 31 can be prevented, so that safety of the driver can be improved.

(7) The in-vehicle device 3 is the air conditioner 31, and the item to be controlled is a set temperature in the vehicle. The restriction unit 213 restricts the adjustable amount of the set temperature in one adjustment instruction to a predetermined temperature. Thus, a remote operation for a large adjustment width in the set temperature inside the vehicle can be suppressed.

(8) The in-vehicle device 3 is the audio device 32, and the item to be controlled is a set volume of the audio device 32. The restriction unit 213 reduces the upper limit of the adjustment width of the set volume to be lower than a predetermined upper limit value, and increases the lower limit of the adjustment width to be higher than a predetermined lower limit value. Thus, a remote operation for a large adjustment width in the set volume of the audio device 32 can be suppressed.

(9) The in-vehicle device 3 is the dimming device 35, which adjusts the transmittance of the dimming glass installed in the vehicle body (the sunroof, the rear side window glass, and the like), and the item to be controlled is the transmittance of the dimming glass. The restriction unit 213 restricts the adjustable amount of the transmittance in one adjustment instruction to a predetermined value. Thus, a significant change in the transmittance of the dimming glass by the remote operation can be suppressed.

According to the present embodiment, the following operation and effects are further achievable.

(1) The user terminal 2 includes: the operation unit 25 as an input unit; and the storage unit 22, and controls the in-vehicle device 3 via the IVI system. The storage unit 22 stores beforehand registration information indicating a registration status of the user terminal 2 with respect to the in-vehicle device 3. The user terminal 2 further includes: the reception unit 211, which receives a change instruction for the setting item of the in-vehicle device 3 that has been input via the operation unit 25; and the restriction unit 213, which enables or disables either the input of the change instruction or the reception of the change instruction, based on the registration information. Thus, an uncomfortable feeling of an occupant to be caused by remotely operating the in-vehicle device can be suppressed.

(2) The user terminal 2 further includes a display unit 24. The reception unit 211 outputs screen information for displaying an operation screen capable of receiving a change instruction to the display unit 24, and receiving the change instruction for the operation screen via the operation unit 25. The reception unit 213 edits the screen information to enable or disable input of the change instruction for the operation screen, and outputs the edited screen information to the display unit 24, or controls whether to output the change instruction for the operation screen to the in-vehicle device 3, thereby enabling or disabling reception of the change instruction in the in-vehicle device 3.

(3) The user terminal 2 further includes the determination unit 212 as a determination unit that determines whether the user terminal 2 is an unregistered terminal, which is not registered to be used for the in-vehicle device 3, based on the registration information. In a case where it is determined that the user terminal 2 is an unregistered terminal, the restriction unit 213 enables the change instruction to the audio device 32 or the air conditioner 31. Thus, an excessive change in internal vehicle environment by the unregistered user who is not registered in the IVI system can be suppressed.

(4) In a case where it is determined that the user terminal 2 is an unregistered terminal, the restriction unit 213 disables the change instruction to the illumination device 33, the dimming device 35, and the traveling sound generation device 34. Thus, an excessive change in internal vehicle environment by the unregistered user who is not registered in the IVI system can be suppressed.

(5) In a case where it is determined that the user terminal 2 is an unregistered terminal, the determination unit 212 transmits a signal including a screen display request for registering the user terminal 2 to be used for the in-vehicle device 3 to the IVI system (the control apparatus 1). Thus, convenience of the user who uses the IVI system can be improved.

While the user terminals 2A and 2B are connected to the IVI system through Wi-Fi, by the way, the IVI system receives a music reproduction request from each control application of the user terminals 2A and 2B in some cases.

Here, a mechanism of music reproduction in the IVI system will be described. When the user operates the user terminal 2 to request the IVI system to reproduce music, its reproduction request is transmitted to the IVI system through Wi-Fi. When the IVI system receives the reproduction request, Bluetooth (hereinafter, abbreviated as BT in some cases) connection between the IVI system and the user terminal 2 is established. In this situation, authentication processing is performed, as necessary. When the BT connection with the IVI system is established, the user terminal 2 starts transferring music data through Bluetooth. The IVI system sequentially outputs the received music data to the audio device. In this manner, streaming reproduction of music is performed.

On the other hand, only one of the user terminals 2 connected with the IVI system is capable of transferring the music data through Bluetooth. In consideration of such a Bluetooth limitation, there is a method in which the IVI system does not receive a new reproduction request from another user terminal until the streaming reproduction that is being performed ends, and receives the reproduction request between pieces of music. However, in a case of receiving the reproduction request between pieces of music, Bluetooth authentication processing and connection establishment processing are performed between pieces of music. Hence, it may be difficult to smoothly transition to the next music reproduction. For this reason, in the present embodiment, the IVI system (the control apparatus 1) is configured as follows in such a manner that even in a case where the music reproduction requests are made from a plurality of user terminals 2, music corresponding to each reproduction request can be smoothly reproduced.

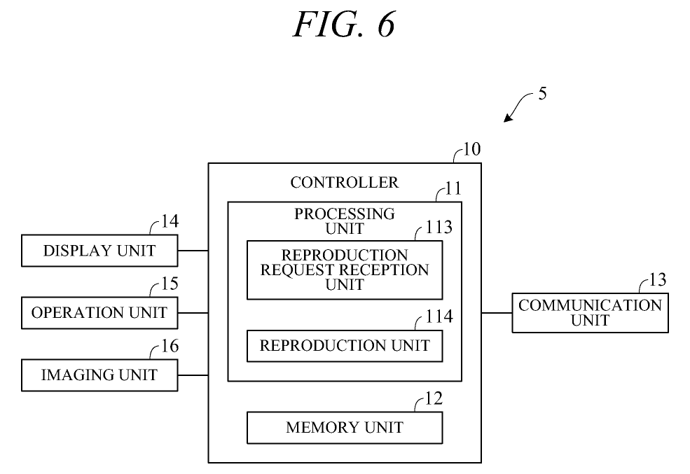

FIG. 6 is a block diagram illustrating a configuration of main components of a reproduction apparatus 5. The reproduction apparatus 5 reproduces music in response to a music reproduction request transmitted from the user terminal 2, and constitutes a part of the control apparatus 1 in FIG. 1A.

As illustrated in FIG. 6, the reproduction apparatus 5 includes the controller 10, the communication unit 13, the display unit 14, the operation unit 15, and the imaging unit 16. By executing a program stored in the storage unit 12, the processing unit 11 functions as a reproduction request reception unit 113 and a reproduction unit 114. The storage unit 12 stores a reproduction reservation list to be described later.

The reproduction request reception unit 113 receives a music reproduction request from the user terminals 2A and 2B connected through Wi-Fi.

When the reproduction request reception unit 113 receives the music reproduction request, the reproduction unit 114 establishes the BT connection with the user terminal 2 (assumed to be the user terminal 2B) of a reproduction request source in response to the reception of the reproduction request, and starts receiving the music data transferred from the user terminal 2B through Bluetooth. The reproduction unit 114 sequentially outputs the music data received from the user terminal 2B to the audio device 32. In this manner, streaming reproduction of music is started.

While the streaming reproduction of the music is being performed, when a new reproduction request from a different user terminal 2 (assumed to be the user terminal 2A) is received by the reproduction request reception unit 113, the reproduction unit 114 records (registers) information corresponding to such a reproduction request in the reproduction reservation list. The information (hereinafter, referred to as reservation information) recorded in the reproduction reservation list includes a music ID, a local name of the user terminal of the reproduction request source, and the like.

When the streaming reproduction that is being performed ends, the reproduction unit 114 performs processing in accordance with the new reproduction request. Specifically, the reproduction unit 114 reads the above reservation information from the reproduction reservation list, and changes a Bluetooth connection destination from the user terminal 2B to the user terminal 2A, based on the reservation information that has been read.

Then, the reproduction unit 114 starts receiving the music data transferred from the user terminal 2A through Bluetooth. The reproduction unit 114 sequentially outputs the music data received from the user terminal 2A to the audio device 32. Thus, streaming reproduction of new music is started. Note that in a case where a plurality of pieces of reservation information are registered in the reproduction reservation list, the reproduction unit 114 may read reservation information having the oldest registration time, or may read reservation information selected in accordance with any other criterion.

Note that while the streaming reproduction based on the reproduction request of the user terminal 2B is being performed, when a new reproduction request from the user terminal 2A is received, the reproduction unit 114 may transmit, to the user terminal 2B, screen information for selecting whether to disconnect the BT connection. The user terminal 2B displays a screen based on the screen information that has been received (hereinafter, referred to as a disconnection selection screen) on the display unit 24.

When the user of the user terminal 2B selects disconnection of the BT connection on the disconnection selection screen via the operation unit 25, a disconnection instruction of the BT connection is transmitted from the user terminal 2B to the reproduction apparatus 5. Upon receipt of such a disconnection instruction, the reproduction unit 114 disconnects the BT connection from the user terminal 2B.

In addition, the streaming reproduction based on the reproduction request from the user terminal 2B ends. When performing processing in accordance with the reproduction request from the user terminal 2A, the reproduction unit 114 may transmit, to the user terminal 2A, screen information for selecting whether to start the music reproduction. The user terminal 2A displays a screen based on the screen information that has been received (hereinafter, referred to as a start selection screen) on the display unit 24.

When the user of the user terminal 2A selects reproduction start on the start selection screen via the operation unit 25, a reproduction start instruction is transmitted from the user terminal 2A to the reproduction apparatus 5. Upon receipt of the reproduction start instruction, the reproduction unit 114 changes the Bluetooth connection destination from the user terminal 2B to the user terminal 2A, based on the reservation information that has been read from the reproduction reservation list. Then, the reproduction unit 114 starts receiving the music data transferred from the user terminal 2A through Bluetooth. Thus, streaming reproduction of new music is started. On the other hand, in a case where the user of the user terminal 2A selects reproduction cancellation on the reproduction start selection screen, streaming reproduction of new music is not started, and the BT connection between the user terminal 2B and the reproduction apparatus 5 is maintained.

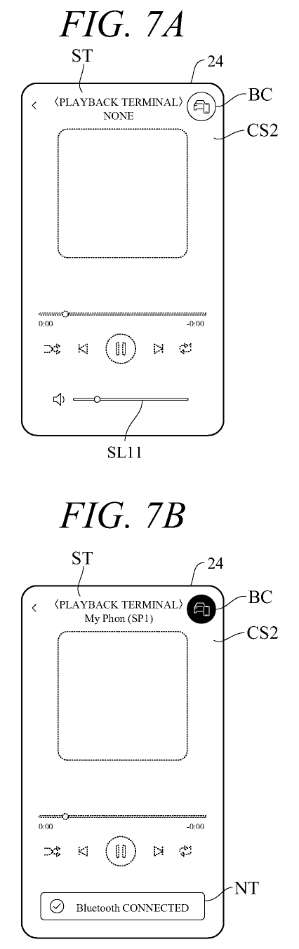

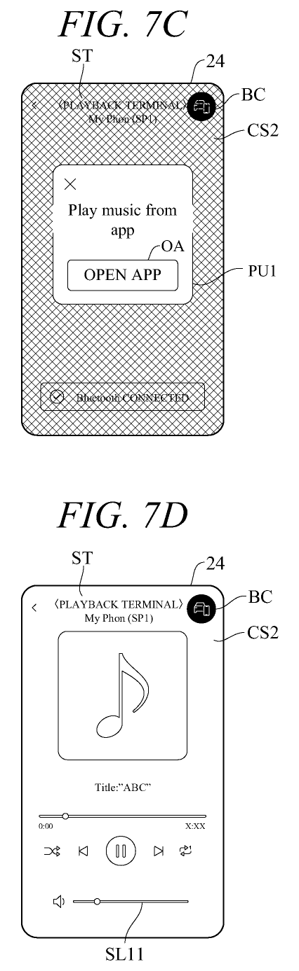

FIGS. 7A to 7D are diagrams illustrating examples of an operation screen of the user terminal 2A when requesting music reproduction. FIG. 7A illustrates a change operation screen CS2 of the audio device 32 to be displayed when the icon IC2 on the main screen MS is tapped, while neither the user terminal 2A nor the user terminal 2B is in the BT connection with the IVI system (the reproduction apparatus 5). The change operation screen CS2 includes a slider SL11 for adjusting a set temperature of the air conditioner 31, a Bluetooth connection button (hereinafter, simply referred to as a connection button) BC, and a display region ST indicating a user terminal that is reproducing music.

When the connection button BC is tapped, the BT connection request is transmitted to the IVI system (the reproduction apparatus 5), and Bluetooth authentication processing and connection establishment processing for the user terminal 2A are performed in the IVI system. When the BT connection is established, the change operation screen CS2 is switched to a state of FIG. 7B.

As illustrated in FIG. 7B, when the BT connection is established, the display color of the connection button BC changes from white indicating an unconnected state to black indicating a connected state. In addition, a notification banner NT indicating that the BT connection between the user terminal 2A and the IVI system is established is displayed. In the display region ST, a message indicating that the user terminal 2A is connected with the IVI system is displayed. Then, as illustrated in FIG. 7C, on the change operation screen CS2, a pop-up dialog PU1 for prompting activation of an application for music reproduction (hereinafter, referred to as a music reproduction application) is displayed. Note that a character string "SP1" displayed in the display region ST is a local name (a device name) of the user terminal 2A.

When an application start button OA of the pop-up dialog PU1 is tapped, the music reproduction application is started. When the user operates the music reproduction application via the operation unit 25 and instructs a reproduction start of music "ABC", a reproduction request is transmitted to the IVI system. When the IVI system starts reproducing the music "ABC" in response to such a reproduction request, the change operation screen CS2 is switched to a state indicating that the music "ABC" is being reproduced as illustrated in FIG. 7D.

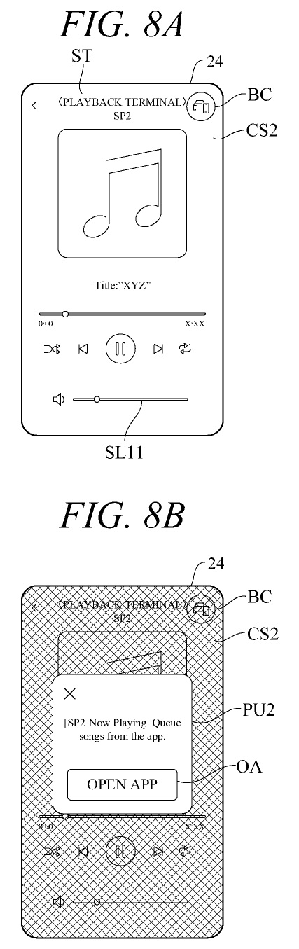

FIGS. 8A to 8B are diagrams for describing reservation of the music reproduction. FIG. 8A illustrates the change operation screen CS2 for the audio device 32 to be displayed when the icon IC2 on the main screen MS of the user terminal 2A is tapped while the user terminal 2B is reproducing music "XYZ". A character string "SP2" displayed in the display region ST of the change operation screen CS2 is the local name of the user terminal 2B.

When the connection button BC on the change operation screen CS2 is tapped, a pop-up dialog PU2 is displayed on the change operation screen CS2 as illustrated in FIG. 8B. In the pop-up dialog PU2, a message is displayed indicating that the user terminal 2B is reproducing music, more specifically, the IVI system is reproducing music, based on a request from the user terminal 2B. In addition, in the pop-up dialog PU2, a message is displayed indicating that it is possible to make a reproduction reservation on the music reproduction application.

When the application start button OA of the pop-up dialog PU2 is tapped, the music reproduction application is started. When the user operates the music reproduction application via the operation unit 25 and instructs a reproduction start of music "ABC", a reproduction request is transmitted to the IVI system. In this case, the reproduction of the music "ABC" is not started, and the reservation information corresponding to the reproduction request for the music "ABC" is registered in the reproduction reservation list. Thus, reproduction of the music "ABC" is reserved. When the reproduction of the music "XYZ" ends, the connection destination of Bluetooth is changed from the user terminal 2B to the user terminal 2A, based on the reservation information registered in the reproduction reservation list, and the streaming reproduction of the music "ABC" is started.

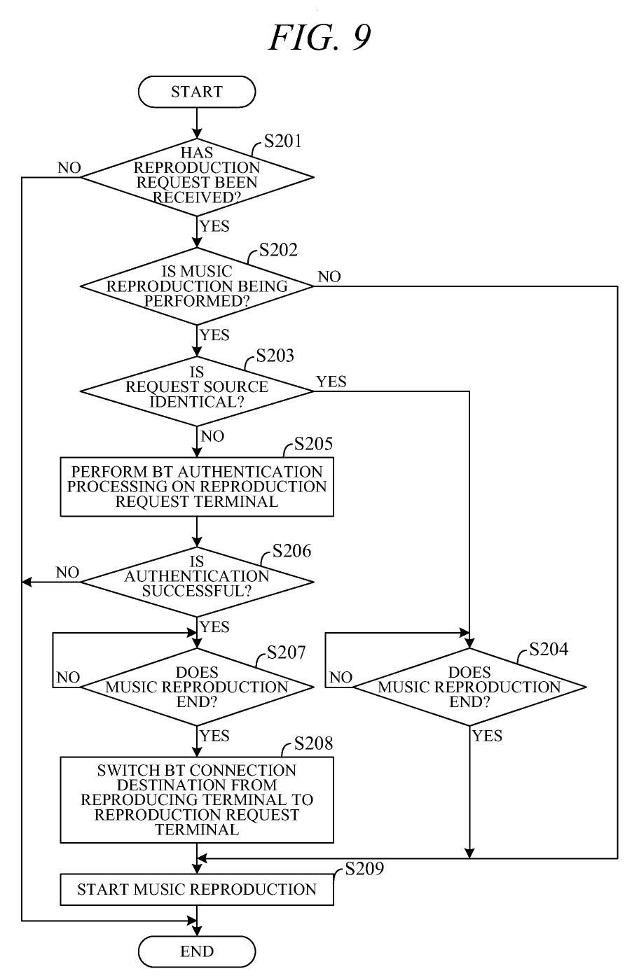

FIG. 9 is a flowchart illustrating an example of processing performed by the controller 10 of the reproduction apparatus 5 in accordance with a predetermined program. The processing illustrated in this flowchart is started when the user operates the user terminal 2 and taps the icon IC2 on the main screen MS, and is repeated at a predetermined cycle while the change operation screen CS2 is displayed on the display unit 24.

First, in step S201, the controller 10 determines whether a music reproduction request has been received from the user terminal 2. In a case where a negative determination is made in step S201, the controller 10 ends the processing. In a case where an affirmative determination is made in step S201, the controller 10 determines whether the music reproduction is being performed in step S202. In a case where a negative determination is made in step S202, the controller 10 proceeds to a process of step S209.

In a case where an affirmative determination is made in step S202, the controller 10 determines in step S203 whether a request source of the music that is being reproduced (hereinafter, referred to as a terminal that is reproducing the music) is identical to a transmission source (hereinafter, referred to as a reproduction request terminal) of the reproduction request received in step S201. In a case where an affirmative determination is made in step S203, the controller 10 waits until the music reproduction that is being performed ends in step S204, and proceeds to the process of step S209.

In a case where a negative determination is made in step S203, the controller 10 performs the Bluetooth authentication processing on the reproduction request terminal in step S205. In step S206, the controller 10 determines whether the authentication is successful. In a case where a negative determination is made in step S206, the controller 10 ends the processing.

In a case where an affirmative determination is made in step S206, the controller 10 waits until the music reproduction that is being performed ends in step S207. When the music reproduction that is being performed ends, the controller 10 switches the Bluetooth connection destination from the terminal that is reproducing the music to the reproduction request terminal in step S208. In step S209, the controller 10 starts music reproduction, based on the reproduction request received in step S201.

According to the embodiments described heretofore, the following effects are achievable.

(1) The control apparatus 1 functions as a part of the IVI system, and reproduces a media content (for example, music). The control apparatus 1 includes: the reproduction request reception unit 113, which receives a reproduction request for a first media content from the user terminal 2B out of the user terminal 2B as a first user terminal and the user terminal 2A as a second user terminal, the user terminal 2A and the user terminal 2B being communicably connected through Wi-Fi as a first communication mode; and the reproduction unit 114, which receives the first media content from the user terminal 2B through Bluetooth as a second communication mode in response to reception of a reproduction request for the first media content, and which starts reproduction of the first media content that has been received, the second communication mode being capable of reproducing a media content and different from the first communication mode. While the first media content is being reproduced, when the reproduction request reception unit 113 receives a reproduction request for a second media content from the user terminal 2A in the first communication mode, the reproduction unit 114 changes a connection destination in the second communication mode from the user terminal 2B to the user terminal 2A in response to reception of the reproduction request for the second media content after the reproduction of the first media content ends, and starts reproduction of the second media content in the second communication mode. Thus, while the music reproduction is being performed, when the reproduction request is received from another user terminal, it becomes possible to start the music reproduction based on the reproduction request immediately after the music reproduction that is being performed ends. As a result, an occurrence of unnecessary time between pieces of music can be suppressed.

(2) Upon reception of the reproduction request for the second media content from the user terminal 2A, the reproduction request reception unit 113 transmits, to the user terminal 2B, information for selecting whether to disconnect the connection in the second communication mode. Thus, the user who is reproducing the music is able to recognize that there is a reproduction request from another user. In addition, by disconnecting the unnecessary connection between the IVI system and the user terminal, the processing load on the IVI system can be reduced. Furthermore, the battery consumption amount of the user terminal can be reduced.

(3) When starting the reproduction of the second media content in the second communication mode, the reproduction request reception unit 113 transmits, to the user terminal 2A, information for selecting whether to start the reproduction of the second media content. Thus, for example, in a case where it is no longer necessary for the user who has requested the music reproduction to reproduce the music before the music reproduction starts, it becomes possible to suppress unnecessary music reproduction.

The above embodiments may be modified into various modes. Hereinafter, modifications will be described. In the above embodiment, the restriction unit 213 edits the change operation screen of the in-vehicle device 3 to be adjusted, and prohibits the input of the adjustment instruction that exceeds the predetermined restriction into the operation unit 25. However, the restriction unit may prohibit reception of the adjustment instruction that exceeds the predetermined restriction. More specifically, the restriction unit may edit a change instruction for the in-vehicle device 3 to be adjusted (an adjustment instruction for the item to be controlled) that has been input on the change operation screen so as to fall within a predetermined restriction, and may receive an edited change instruction.

In addition, in the above embodiment, the restriction unit 213 edits the screen information of the change operation screen to make the operation on the change operation screen of the in-vehicle device 3 inoperable, based on the registration information, and disables the input of the change instruction (the adjustment instruction of the item to be controlled). However, the restriction unit may enable or disable reception of the change instruction on the change operation screen. More specifically, the restriction unit may enable or disable the change instruction that has been input on the change operation screen for the in-vehicle device 3 to be adjusted. In this case, the change instruction is output to the control apparatus 1 when it is enabled, and is not output when it is disabled.

The communication terminal in the above embodiment can also be configured as a control method for controlling the in-vehicle device 3 via the IVI system from another point of view. That is, it is also possible to configure as a control method including: a step of reading, from a storage unit, adjustment width information that defines an adjustment width of an item to be controlled of an in-vehicle device; a reception step of receiving an input operation of an adjustment instruction for the item to be controlled; and a restriction step of restricting either an input of the adjustment instruction or reception of the adjustment instruction in such a manner that a predetermined restriction is imposed on the adjustment instruction, based on the adjustment width defined by the adjustment width information.

Furthermore, it is also possible to configure the present invention by replacing the above control method with a program for causing a computer of a communication terminal that controls the in-vehicle device 3 via the IVI system to execute the program. Furthermore, the present invention can be configured by replacing the above control method with a computer-readable storage medium in which such a program is recorded.

The above embodiment can be combined as desired with one or more of the aforesaid modifications. The modifications can also be combined with one another.

According to the present invention, an uncomfortable feeling of an occupant to be caused by remotely operating the in-vehicle device can be suppressed.

Above, while the present invention has been described with reference to the preferred embodiments thereof, it will be understood, by those skilled in the art, that various changes and modifications may be made thereto without departing from the scope of the appended claims.

What is claimed is:

1. A non-transitory computer-readable storage medium storing a control program configured to be executed by a computer of a user terminal including an input unit and a memory, the control program for controlling an in-vehicle device, wherein
the memory stores, in advance, adjustment width information defining an adjustment width of an item to be controlled of the in-vehicle device,
the control program causes the computer to perform:
receiving an adjustment instruction for the item to be controlled input via the input unit; and
restricting either an input of the adjustment instruction or reception of the adjustment instruction to impose a predetermined restriction on the adjustment instruction, based on the adjustment width defined by the adjustment width information.

2. The storage medium according to claim 1, wherein
the user terminal further includes a display unit, and
the control program causes the computer to perform:
the receiving including outputting screen information for displaying an operation screen capable of receiving an adjustment instruction to the display unit and receiving the adjustment instruction for the operation screen via the input unit; and
the restricting including editing the screen information to enable or disable input of the adjustment instruction for the operation screen, and outputting the screen information edited to the display unit, or controlling whether to output the adjustment instruction for the operation screen to the in-vehicle device so as to enable or disable reception of the adjustment instruction in the in-vehicle device.

3. The storage medium according to claim 1, wherein
the control program causes the computer to perform:
the restricting including prohibiting an input of the adjustment instruction exceeding a predetermined restriction into the input unit.

4. The storage medium according to claim 1, wherein
the control program causes the computer to perform
the restricting including prohibiting reception of the adjustment instruction input via the input unit and exceeding a predetermined restriction.

5. The storage medium according to claim 1, wherein
the control program causes the computer to perform
the restricting including conducting at least one of reducing an upper limit of the adjustment width and increasing a lower limit of the adjustment width.

6. The storage medium according to claim 1, wherein
the control program causes the computer to perform
the restricting including reducing an adjustable amount per the adjustment instruction defined by the adjustment width information.

7. The storage medium according to claim 1, wherein
the memory further stores registration information indicating a registration status of the user terminal with respect to the in-vehicle device, and
the control program causes the computer to further perform
determining whether the user terminal is a registered terminal registered in the in-vehicle device or an unregistered terminal not registered in the in-vehicle device, based on the registration information.

8. The storage medium according to claim 1, wherein
the memory further stores user information from which an age of the user of the user terminal is identifiable,
the control program causes the computer to further perform
determining whether the user is an adult, based on the user information,
the predetermined restriction includes a first restriction and a second restriction stricter than the first restriction, and
the control program causes the computer to perform
the restricting including restricting an input of the adjustment instruction in such a manner that in a case where it is determined that the user is an adult, imposing the first restriction on the adjustment instruction, and in a case where it is determined that the user is a child, imposing the second restriction on the adjustment instruction.

9. The storage medium according to claim 1, wherein
the in-vehicle device includes at least one of an illumination device, an audio device, an air conditioner, and a dimming device.

10. The storage medium according to claim 9, wherein
the in-vehicle device is an illumination device,
the item to be controlled is luminance of the illumination device, and
the control program causes the computer to perform
the restricting including reducing an upper limit of the adjustment width of the luminance of the illumination device to be lower than a predetermined upper limit value, and increasing a lower limit of the adjustment width to be higher than a predetermined lower limit value.

11. The storage medium according to claim 9, wherein
the in-vehicle device is an air conditioner, and
the control program causes the computer to perform
the restricting including prohibiting switching between outside air introduction and inside air circulation by the air conditioner.

12. The storage medium according to claim 9, wherein
the in-vehicle device is an air conditioner, and the item to be controlled is a set temperature in a vehicle in which the in-vehicle device is installed, and
the control program causes the computer to perform
the restricting including restricting an adjustable amount of the set temperature per the adjustment instruction to a predetermined temperature.

13. The storage medium according to claim 9, wherein
the in-vehicle device is an audio device, and the item to be controlled is a set volume of the audio device, and
the control program causes the computer to perform
the restricting including reducing an upper limit of the adjustment width of the set volume to be lower than a predetermined upper limit value, and increasing a lower limit of the adjustment width to be higher than a predetermined lower limit value.

14. The storage medium according to claim 9, wherein
the in-vehicle device is a dimming device, the dimming device adjusting transmittance of a dimming glass installed in a body of a vehicle in which the in-vehicle device is installed, and the item to be controlled is the transmittance of the dimming glass, and
the control program causes the computer to perform
the restricting including restricting an adjustable amount of the transmittance per the adjustment instruction to a predetermined value.

15. A control method for controlling an in-vehicle device, the control method comprising:
reading from a memory, adjustment width information defining an adjustment width of an item to be controlled of the in-vehicle device;
receiving an adjustment instruction for the item to be controlled input via the input unit; and
restricting either an input of the adjustment instruction or reception of the adjustment instruction to impose a predetermined restriction on the adjustment instruction, based on the adjustment width defined by the adjustment width information.

16. A communication terminal comprising:
a microprocessor;
a memory connected to the microprocessor and storing adjustment width information defining an adjustment width of an item to be controlled of the in-vehicle device; and
an input unit configured to be operated by a user and configured to be able to input an adjustment instruction for the item to be controlled, wherein
the microprocessor is configured to perform:
receiving an adjustment instruction for the item to be controlled input via the input unit; and
restricting either an input of the adjustment instruction or reception of the adjustment instruction to impose a predetermined restriction on the adjustment instruction, based on the adjustment width defined by the adjustment width information.
